(19) United States
(12) Patent Application Publication
(10) Pub. No.: US 2007/0217053 A1
(43) Pub. Date: Sep. 20, 2007

(54) Storage device

(75) Inventor: Masaharu Sugimoto, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/483,528

(22) Filed: Jul. 11, 2006

(30) Foreign Application Priority Data
Mar. 16, 2006 (JP) 2006-073389

(51) Int. Cl. G11B 21/02

(52) U.S. Cl. 360/75

(57) ABSTRACT

A storage device includes a controller and a circuit. The controller controls a flying height of a slider from a recording medium as a result of applying voltage between the recording medium and the slider. The slider has a reading element for reproducing information recorded on the recording medium. The circuit makes an electric potential of a reference voltage of a driving circuit and the reading element and an electric potential of the recording medium equal to each other. The driving circuit drives the reading element.

### BACKGROUND OF THE INVENTION

1. Field of the Invention

The present invention relates to a storage device which can prevent damage to a reading element caused by discharge current between a recording medium and a slider.

2. Description of the Related Art

In recent years, the demand for reducing the size of and increasing the storage capacity of a magnetic storage device has resulted in the demand for a magnetic head which can perform high-density recording or reproduction on a recording medium.

An example of such a magnetic head is a composite magnetic head comprising a recording element and a reading element using a magneto-resistive element.

In such a magnetic head, an interval between recording gaps of the magnetic head is reduced to reduce a recording area per one bit of recording data, so that recording density is increased, thereby increasing storage amount.

However, reducing the recording area per one bit of data reduces magnetic field strength for recording data. Therefore, an error tends to occur. As a result, even if the storage capacity can be increased, the reliability with which data is recorded or reproduced is reduced.

Accordingly, even if the interval between the recording gaps of the magnetic head is reduced, to sufficiently maintain the strength of the magnetic field applied to a recording surface of a recording medium, it is necessary to reduce the gap between the recording head and the recording medium.

In one method of reducing this gap, a flying height of a slider having the magnetic head is controlled as a result of generating electrostatic attraction force by applying voltage between the slider and the recording medium.

This method of controlling the flying height of the slider by using electrostatic attraction force can maintain a flying height of tens of nanometers (nm) by properly controlling, for example, a change in the flying height of the slider.

However, since the static electricity generated by, for example, the application of voltage accumulates on, for example, the recording medium, variations in the flying height of the slider occur due to a disturbance or other factors, causing the flying height to be reduced to a value that is smaller than a predetermined distance and an electrical potential difference between the slider and the recording medium to exceed the dielectric strength of air. In such a case, electric discharge occurs between the slider and the recording medium.

When such electric discharge occurs in the magnetic storage device, the reproduction magneto-resistive element of the magnetic head that is exposed at a floating surface of the slider is damaged. The magneto-resistive element is thermally damaged because discharge current flowing in the magnetic head due to the electrical potential difference flows into the magneto-resistive element having an insulation resistance that is lower than those of the other portions.

### SUMMARY OF THE INVENTION

A storage device according to an aspect of the present invention includes a controller and a circuit. The controller controls a flying height of a slider from a recording medium as a result of applying voltage between the recording medium and the slider. The slider has a reading element for reproducing information recorded on the recording medium. The circuit makes an electric potential of a reference voltage of a driving circuit and the reading element and an electric potential of the recording medium equal to each other. The driving circuit drives the reading element.

By virtue of this structure, the electrical potential of the reading element and the electrical potential of the recording medium are the same, so that it is possible to prevent damage to the reading element caused by electric discharge.

### BRIEF DESCRIPTION OF THE DRAWINGS

FIG. 1 illustrates a magnetic storage device;

FIG. 2 illustrates a power supply circuit;

FIG. 3 illustrates a magnetic head;

FIG. 4 illustrates the relationship between flying height and voltage;

FIG. 5 shows a first illustration of a main portion of a magnetic storage device according to an embodiment;

FIG. 6 illustrates power supply connections in a spindle motor; and

FIG. 7 shows a second illustration of a main portion of a magnetic storage device according to another embodiment.

### DESCRIPTION OF THE PREFERRED EMBODIMENTS

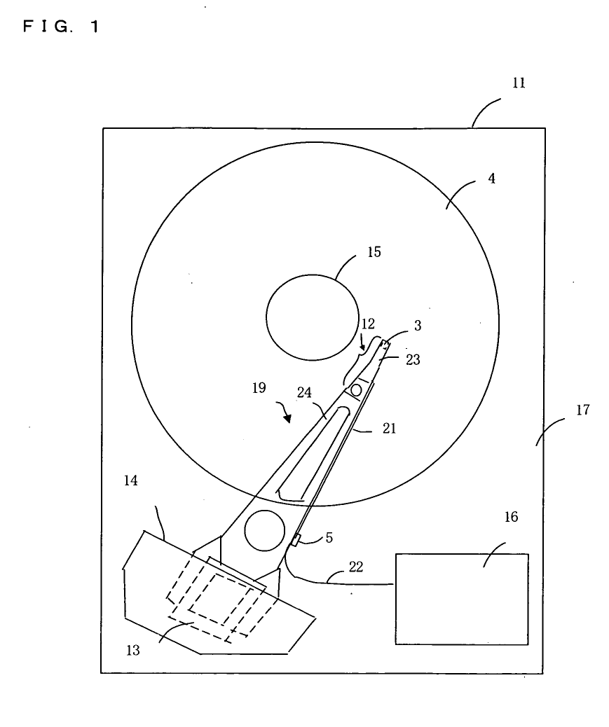

FIG. 1 illustrates a magnetic storage device.

In a magnetic storage device 11, a head gimbal assembly 12, a head stack assembly 19, a driving unit 14, and a spindle motor 15 are mounted to a base 17. A slider 3 having a magnetic head 2 is mounted in the head gimbal assembly 12. The head stack assembly 19 has the head gimbal assembly 12 mounted thereto. The driving unit 14 includes a voice coil motor 13 for driving the head stack assembly 19. The spindle motor 15 is used to rotate a recording medium 4.

A control circuit 18, which includes, for example, a disc controller, for driving the aforementioned parts, is provided on the back of the base 17.

The head gimbal assembly 12 includes the slider 3 and a suspension 23 to which the slider 3 is mounted, and is connected to an arm 24 of the head stack assembly 19 supporting the suspension.

A command from the control circuit 18 causes the voice coil motor 13 to be driven, thereby moving the head stack assembly 19, so that the magnetic head 2 is moved.

A relay flexible printed circuit board 21 for connecting the magnetic head 2 and a pre-amplifier 5 to each other and a pre-amplifier flexible printed circuit board 22 to which the pre-amplifier 5 is mounted are mounted to a side surface of the head stack assembly 19. The pre-amplifier flexible printed circuit board 22 is connected to the control circuit 18 via a securing member 16.

The pre-amplifier 5 is connected to the magnetic head 2 and the control circuit 18 and performs amplification of a signal for data recording and amplification for data reproduction.

The control circuit 18 includes a read-write circuit for performing recording and reproduction of data, a positioning control circuit for controlling positioning of the magnetic head 2, a rotation control circuit for controlling rotation of the recording medium 4, a power supply 6 which applies a predetermined voltage between the recording medium 4 and the slider 3, and a memory 63 which previously stores slider numbers and predetermined values for setting predetermined voltages that are applied between recording media 4 and respective sliders 3. When a plurality of sliders 3 are used, each slider number is a number which specifies the slider 3 to which voltage is applied and the recording medium 4 corresponding thereto.

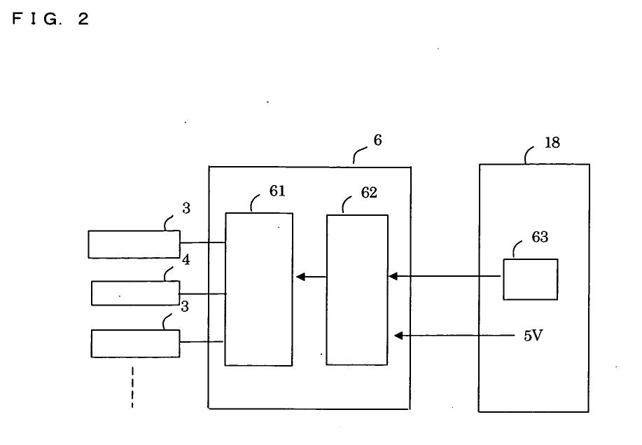

FIG. 2 illustrates a power supply circuit.

The control circuit 18 receives electric power to be used in the magnetic storage device 11, such as that having a value of 5 V, from a host (not shown). The control circuit 18 supplies a portion of the electric power of 5 V to the power supply 6.

The power supply 6 generates electric power which is equal to or less that 5 V on the basis of the electric power of 5 V supplied from the control circuit 18, the electric power that is generated being used to control a flying height. The voltage of the power supply 6 can be varied.

The power supply 6 includes a voltage application circuit 16 and a controller circuit 62. In the control circuit 18, control information for controlling the flying height of a slider 3, that is, information including the slider number and the predetermined value indicating the predetermined voltage that is applied between the slider 3 and the corresponding recording medium 4 is received, and a command is given to the controller circuit 62. Then, the control circuit 62 applies to the voltage application circuit 61 a voltage corresponding to the predetermined value so as to be applied between the slider 3 and the corresponding recording medium 4 that are selected by the slider number. For example, if the predetermined value is 3 and the slider number is 1, 3 V is applied between the slider 3 whose slider number is 1 and the corresponding recording medium 4. The voltage application circuit 61 includes a plurality of power supply circuits for the plurality of sliders 3. When the controller circuit 62 does not give out a command, the voltage of the power supply 6 is not applied between the slider 3 and the corresponding recording medium 4.

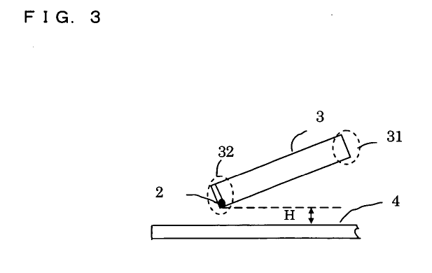

FIG. 3 illustrates a magnetic head.

For the magnetic head 2, a composite type including a recording element and a reading element using a magneto-resistive element (hereafter referred to as “MR element 7”) is primarily used.

The magnetic head 2 is provided at a front end 32 of the slider 3. The slider 3 floats from a surface of the recording medium 4 by making use of air current that is produced along the surface of the recording medium when the recording medium 4 rotates. As a result, the magnetic head 2 that is provided at the front end 32 of the slider 3 can record or reproduce data without contacting the surface of the recording medium 4.

The slider 3 is such that, when incoming airflow is generated by the rotation of the recording medium 4, a rear end 31 of the slider 3 where air flows in floats at a high position and the front end 32 of the slider 3 where the air flows out floats at a low position.

Therefore, a distance H between the surface of the recording medium 4 and the front end 32 of the slider 3 opposing the recording medium 4 corresponds to a flying height.

The flying height of the slider 3 from the recording medium 4 is determined by, for example, the rotational speed of the spindle motor 15, a push-down force produced by a load from the head stack assembly 19 and positive and negative pressures produced on the basis of forms of rails of the slider 3, and floating pitch angle. However, since it is difficult to obtain a predetermined flying height by a mechanical adjustment along, it is adjusted by an electrostatic attraction force that is produced by voltage.

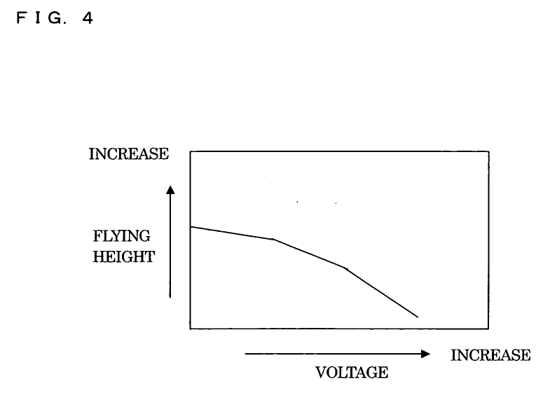

FIG. 4 illustrates the relationship between the flying height and voltage.

As shown in FIG. 4, the flying height is reduced as supply voltage is increased.

Accordingly, application of a voltage between the slider 3 and the corresponding recording medium 4 generates an electrostatic attraction force that is proportional to the square of the electric potential difference between the slider 3 and the corresponding recording medium 4 and that is inversely proportional to the square of the distance between the slider 3 and the corresponding recording medium 4. A predetermined flying height can be set by this electrostatic attraction force.

Therefore, to obtain a predetermined flying height, the flying height is adjusted by using electrostatic attraction force when the magnetic storage device 11 is being manufactured.

To perform the adjustment, a supply voltage, which corresponds to the predetermined flying height, is determined by adjusting voltage while measuring the flying height with an existing optical flying height measuring device at the manufacturing stage.

A predetermined value corresponding to the predetermined voltage at which the flying height is adjusted to an optimal flying height is, along with a slider number, stored as control information in the memory 63 of the control circuit 18.

A supply voltage that is equal to or less than a few volts for controlling the flying height is added between the slider 3 and the MR element 7. In the voltage range for controlling the flying height, they are separated by a distance not allowing electric discharge to occur.

An insulating alumina substrate is inserted between the MR element 7 and a surface of the slider (AlTiC substrate). Therefore, the distance between the MR element 7 and the slider 3 is approximately 1000 nm, which corresponds to the thickness of the alumina substrate, and is a few tens of times greater than the flying height. Further, since the isolation voltage of the alumina substrate is equal to or greater than the isolation voltage of air, discharge breakdown does not occur at a supply voltage that is equal to or less than a few volts.

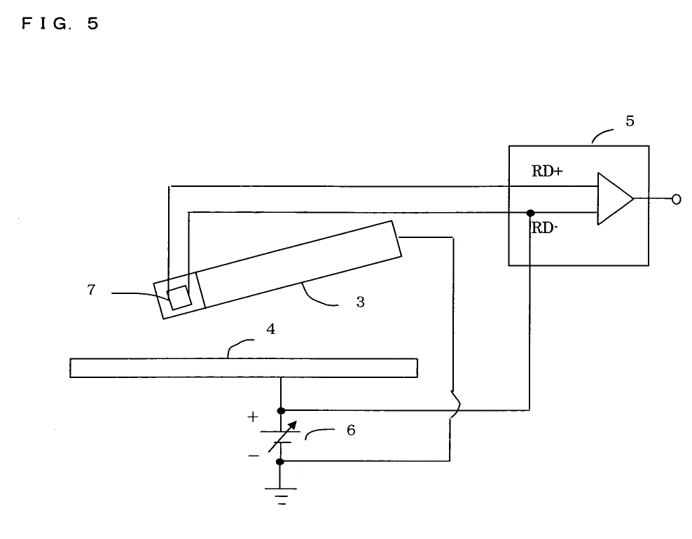

FIG. 5 shows a first illustration of a main portion of a magnetic storage device according to an embodiment.

A circuit for preventing damage to an MR element 7 of a magnetic storage device 11 connects a recording medium 4, a pre-amplifier 5, and the MR element 7 of the magnetic head 2 to each other. By this connection, the electric potential of the MR element 7 and the electric potential of the recording medium 4 become the same.

That is, the pre-amplifier 5 is connected to the MR element 7 by double-pole signal lines, an RD positive line and an RD negative line (reference voltage), which are read signal lines. The recording medium 4 is connected to one of the double-pole signal lines, the RD negative signal line having the reference voltage. As a result, the electric potentials of the recording medium 4 and the RD negative line of the MR element 7 are the same.

A circuit for controlling a flying height connects a slider 3, the recording medium 4, and a power supply 6.

A positive terminal of the power supply 6 is connected to the recording medium 4, and a negative terminal of the power supply is connected to the slider 3. Since the negative terminal of the power supply is connected to ground via the base 17, the slider 3 is connected to ground.

As a result, a predetermined voltage can be applied between the recording medium 4 and the slider 3.

In the embodiment shown in FIG. 5, since a positive voltage is added to the recording medium 4 and the slider 3 is connected to ground, only one type of voltage can be applied. This is because a plurality of sliders 3 are electrically connected to ground, and a plurality of recording media 4 are electrically connected to the spindle motor 15. Therefore, the supply voltage between the sliders 3 and the corresponding recording media 4 become a common voltage. Consequently, a head stack assembly 19 which allows sliders 3 to be adjusted to a common optimal flying height at the manufacturing stage is selected. In addition, predetermined values corresponding to predetermined voltages for obtaining predetermined flying heights and slider numbers are stored as control information in a memory 63 of a control circuit 18. In this case, the predetermined values corresponding to the slider numbers become the same.

Next, detailed connections in each circuit will be described.

Connection wiring for the circuit for preventing damage to the MR element 7 is as follows.

The RD negative line of the MR element 7 is connected to the positive terminal of the power supply 6, which is set in the control circuit 18 (not shown), through the slider 3, the suspension 23, the relay flexible printed circuit board 21, and the pre-amplifier flexible printed circuit board 22, which are shown in FIG. 1.

The positive terminal of the power supply 6 is connected to a power supply connection terminal 48 of a stationary shaft 41 of a spindle motor 15 from the control circuit 18. By connecting the positive terminal of the power supply 6 to the power supply connection terminal 48, the positive terminal of the power supply 6 is connected to the recording medium 4.

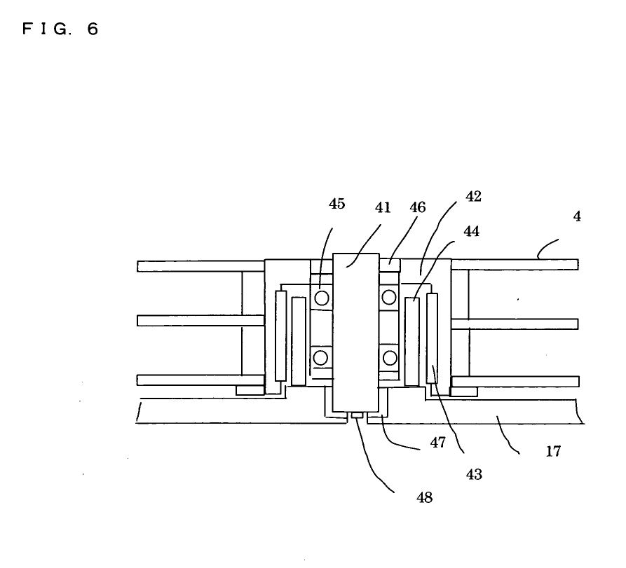

FIG. 6 illustrates power supply connections in the spindle motor.

The stationary-shaft-type spindle motor 15 has a structure in which a hub-driving stator coil 44 and magnet 43, a bearing 45 for producing rotation, a magnetic fluid seal 46 (which prevents, for example, spreading of grease on the bearing), etc., are disposed within a hub 42 (which holds recording media 4) and around the stationary shaft 41 as a center. Rotation of the hub 42 around the stationary shaft 41 as a center causes the recording media 4 to rotate.

The hub 42 is in contact with and electrically connected to inner peripheral surfaces of the recording media 4, and is electrically connected to the stationary shaft 41 by the magnetic fluid seal 46. As a result, the recording media 4 and the stationary shaft 41 of the spindle motor 15 are electrically connected to each other, so that a positive voltage is applied to the recording media 4 by the power supply 6.

The stationary shaft 41 is secured to the base 17. An insulator 47 for preventing electrical connection is provided between the stationary shaft 41 and the base 17 to electrically insulate the stationary shaft 41 and the base 17 from each other.

As a result, the electric potentials of the recording medium 4 and the RD negative line of the MR element 7 are the same.

Connection wiring for the circuit for controlling a flying height is as follows.

As mentioned above, the positive terminal of the power supply 6 is connected to a recording medium 4 via the spindle motor 15.

The negative terminal of the power supply 6 is connected to the slider 3. More specifically, through the suspension 23, the relay flexible printed circuit board 21, and the pre-amplifier flexible printed 22, the slider 3 is connected to the negative terminal of the power supply 6 disposed in the control circuit 18. In addition, the negative terminal of the power supply 6 is connected to ground.

As a result, a predetermined voltage can be applied between the recording medium 4 and the slider 3.

Next, an embodiment in which a different method of applying voltage by a power supply 6 for controlling a flying height is used will be described.

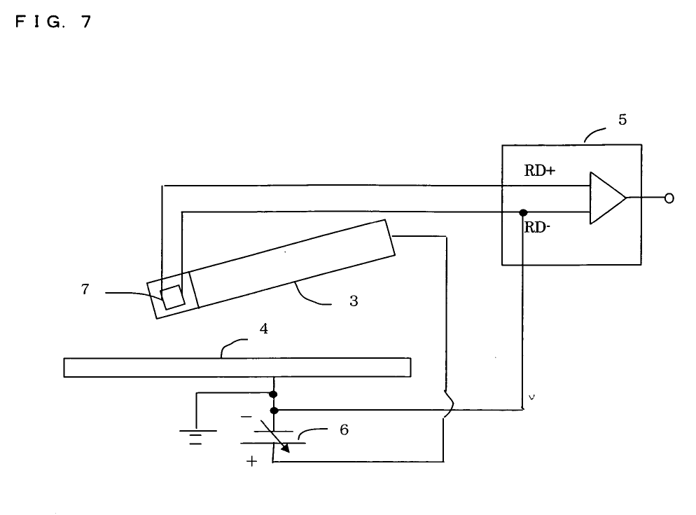

FIG. 7 shows a second illustration of a main portion of a magnetic storage device according to an embodiment.

Since a power supply circuit shown in FIG. 7 for controlling a flying height differs from that shown in FIG. 5, a circuit shown in FIG. 7 that connects an MR element 7 and a recording medium 4 also differs from that shown in FIG. 5.

Detailed connections in each circuit will be described.

Connection wiring for the circuit for preventing damage to the MR element 7 is as follows. Through the slider 3, the suspension 23, the relay flexible printed circuit board 21, and the pre-amplifier flexible printed circuit board 22 (all of which are shown in FIG. 1), an RD negative line of the MR element 7 is connected to the negative terminal of a power supply 6 disposed in a control circuit 18. The negative terminal of the power supply is connected to ground through a base 17. The RD negative line of the MR element 7 is connected to ground.

The recording medium 4 is electrically connected to the base 17 without using the insulator 47 shown in FIG. 5 through a stationary shaft 41 from a hub 42 of a spindle motor 15. Since the base 17 is connected to ground, the recording medium 4 is also connected to ground.

As a result, the electric potentials of the recording medium 4 and the RD negative line of the MR element 7 are the same.

Connection wiring for the circuit for controlling a flying height is as follows.

The positive terminal of the power supply is connected to the slider 3. A connection circuit thereof is such that connection is made from the slider 3 to the positive terminal of the power supply 6 in the control circuit through the suspension 23, the relay flexible printed circuit board 21, and the pre-amplifier flexible printed circuit board 22.

The negative terminal of the power supply is connected to ground through the base 17. As mentioned above, the recording medium is also connected to ground.

As a result, a predetermined voltage can be applied between the slider 3 and the recording medium 4.

In the embodiment shown in FIG. 7, at the manufacturing stage, slider numbers and predetermined values corresponding to predetermined voltages at which flying heights are adjusted to an optimal flying height are stored in a memory 63 in the control circuit 18 for respective sliders 3. This makes it possible to previously obtain the optimal flying height for each slider.

Next, controlling of the flying height will be described.

A magnetic storage device 11 of a ramped loading type will be described.

When the magnetic storage device 11 is activated, a control circuit 18 performs a predetermined amount of seek operation from a ramp mechanism (not shown) to a recording medium 4 by a seek control operation for a slider 3 having a magnetic head 2.

At this time, since a voltage is not yet applied, the slider 3 floats from the recording medium 4 by a predetermined flying height.

Next, to control the flying height, the control circuit 18 obtains a predetermined value corresponding to a supply voltage and a slider number that are stored in a memory 63 and gives a command to a power supply 6. The power supply 6 applies the voltage corresponding to the predetermined value between the slider 3 and the recording medium 4 that are specified by the slider number. Applying this voltage between the recording medium 4 and the slider 3 generates an electric potential difference between the recording medium 4 and the slider 3. As a result, since the recording medium 4 and the slider 3 are polarized into reverse polarities, electrostatic attraction force resulting from Coulomb forces act, causing the slider 3 to float by a predetermined distance.

Then, the control circuit 18 drives the pre-amplifier 5 to perform a read-write operation on the recording medium 4.

However, a disturbance, etc., may cause the distance between the recording medium 4 and the slider 3 to be smaller than the predetermined flying height.

In addition, depending upon the distance between the recording medium 4 and the slider 3, the electric potential difference between the recording medium 4 and the slider 3 may exceed the dielectric strength of air. When the dielectric strength of air is exceeded, electric discharge occurs between the recording medium 4 and an end 32 of the conductive slider 3.

In contrast, the electric potential of the recording medium 4 and the electric potential of the MR element 7 are the same. Therefore, discharge current does not flow to the MR element 7 having the same electric potential, so that the MR element 7 can be prevented from becoming damaged.

Since electrostatic resistance between the slider 3 and the recording medium 4 is high, electric discharge between the slider 3 and the recording medium 4 does not cause damage that affects the reliability of the storage device.

What is claimed is:

1. A storage device comprising:
a controller for controlling a flying height of a slider from a recording medium as a result of applying voltage between the recording medium and the slider, the slider having a reading element for reproducing information recorded on the recording medium; and
a circuit for making an electric potential of a reference voltage of a driving circuit and the reading element and an electric potential of the recording medium equal to each other, the driving circuit driving the reading element.

2. The storage device according to claim 1, wherein the circuit includes double-pole signal lines and a connection circuit, the signal lines connecting the reading element and the driving circuit, the connection circuit connecting one of the double-pole signal lines that has the reference voltage to the recording medium.

3. The storage device according to claim 1, wherein the controller includes a power supply that applies a predetermined voltage between the slider and the recording medium, a first power supply connection circuit that connects the power supply to a stationary shaft of a stationary-shaft-type spindle motor electrically connected to the recording medium, and a second power supply connection circuit that connects the power supply to the slider.

4. The storage device according to claim 3, further comprising an insulator disposed between the stationary shaft and a housing of the storage device to which the stationary shaft is secured.

5. The storage device according to claim 1, wherein the controller includes control information storing unit for storing control information used to apply the voltage between the recording medium and the slider and voltage applying unit for applying the voltage between the recording medium and the slider on the basis of the stored control information.

6. The storage device according to claim 5, wherein, on the basis of the control information, the slider and the recording medium to which the voltage is applied are selected to apply a predetermined voltage corresponding to the selected recording medium and slider.

7. A storage device comprising:
a first line connected with one end of a reading element for reproducing information recorded on a recording medium;
a second line connected with the other end of the reading element;
an amplifier amplifying a voltage difference between the first line and the second line; and
a third line connecting between the recording medium and one of the first line and the second line.
